(19) United States
(12) Patent Application Publication
(10) Pub. No.: US 2002/0088309 A1
(43) Pub. Date: Jul. 11, 2002

(54) Inverted screw removal tool

(76) Inventor: Felix Fezzuoglio, Brooklyn, NY (US)

Correspondence Address: Richard W. Goldstein, 2071 Clove Road, Staten Island, NY, 10304, US

(21) Appl. No.: 09/755,997

(22) Filed: Jan. 8, 2001

(51) Int. Cl. B25B 17/00

(52) U.S. Cl. 81/57.3

(57) ABSTRACT

An inverted screw removal tool comprises a handle and an elongated shaft. The handle is positioned below and parallel to the shaft. The shaft is a thin rotatable rod, with a socket positioned at one end and a shaft gear at an opposite end. The shaft is mounted to the handle with a middle bracket and an end bracket which allow axial rotation of the shaft. A bit extends proximally from the end bracket and has a bit gear in mesh with the shaft gear. When the shaft is rotated, the bit rotates in an opposite direction to selectively engage and rotate inverted screws.

### BACKGROUND OF THE INVENTION

The invention relates to an inverted screw removal tool. In particular, the invention is a tool that may be used in the removal of inverted screws located in tight or cramped spaces. One specific use of the tool may be the removal of a fuel pressure regulator in an automobile, said regulator usually held in place by means of inverted screws. The tool is inserted into the center of the fuel pressure regulator in order to easily and effortlessly remove inverted allen screws. Once the screws are detached, the regulator may be removed for repair.

Inverted screws are used in many instances to hold various components together. Because the “screw head” of these screws face away from the mechanic, he or she may find it difficult and cumbersome to remove these screws because of the lack of space surrounding them and the lack of visibility.

In particular, in an automobile inverted screws are used to hold a fuel pressure regulator in place within the engine. A fuel rail is positioned around the engine. This rail carries the fuel to all of the injectors in the engine. As the fuel travels, the fuel pressure regulator is the last component through which the fuel comes into contact on its way out of the engine compartment. The main function of the fuel pressure regulator is to maintain the pressure in the fuel system.

When it becomes necessary to replace or repair the fuel pressure regulator, a mechanic or automobile owner needs to unscrew and remove inverted screws that hold the regulator in place within the automobile. However, this may be a difficult task because of the tight positioning of the part and the lack of space within which to maneuver one's hand and an appropriate tool. In addition, the screws are inverted, that is they face away from the mechanic. Because of these obstacles, a mechanic often finds it inevitable to remove surrounding engine parts in order to gain access to the regulator. Besides increasing the amount of time and work this practice creates, it also opens up the possibility for error when replacing the parts.

Thus, there exists a need for a specially designed tool which may be employed for removing inverted screws, especially those found in conjunction with a fuel pressure regulator. Such a tool should allow a mechanic to reach behind the regulator and loosen the screws without having to place his or her hands around the regulator.

U.S. Pat. No. 2,018,154 to Scott discloses a wrench having rotatable jaws mounted on the handle for adjustment to various angular relationships. The handle may be either swung laterally or turned on its axis.

U.S. Pat. No. 2,733,745 to Norwood discloses a cable-driven ratchet tool having an offset pistol grip. This grip permits the screwing and unscrewing of screws in areas having only right angle access.

U.S. Pat. No. 3,424,212 to Kemper shows a screw wrench device designed for employment with screws located proximate to additional machine elements.

U.S. Pat. No. 4,010,663 to Rydberg discloses a multiple hand tool having a variety of tools mounted on a single tool handle.

While the available units may be suitable for the particular purpose employed, or for general use, they would not be as suitable for the purposes of the present invention as disclosed hereafter.

### SUMMARY OF THE INVENTION

In the view of the foregoing disadvantages inherent in the prior art, the present invention provides an improved inverted screw removal tool. As such, the general purpose of the present invention, which will be described subsequently in greater detail, is to provide a new and improved inverted screw removal tool which has all the advantages of the prior art and none of the disadvantages.

To attain this, the present invention essentially comprises an inverted screw removal tool comprises a handle and an elongated shaft. The handle is positioned below and parallel to the shaft. The shaft is a thin rotatable rod, with a socket positioned at one end and a shaft gear at an opposite end. The shaft is mounted to the handle with a middle bracket and an end bracket which allow axial rotation of the shaft. A bit extends proximally from the end bracket and has a bit gear in mesh with the shaft gear. When the shaft is rotated, the bit rotates in an opposite direction to selectively engage and rotate inverted screws.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved inverted screw removal tool which has all the advantages of the prior art and none of the disadvantages.

It is another object of the present invention to provide a new and improved inverted screw removal tool which may be easily and efficiently manufactured and marketed.

It is a further object of the present invention to provide a new and improved inverted screw removal tool which is of durable and reliable construction.

An even further object of the present invention is to provide a new and improved inverted screw removal tool which is susceptible to a low cost of manufacture with regard to both materials and labor, and which accordingly is then susceptible of low prices of sale to the consuming public, thereby making such inverted screw removal tool economically available to the buying public.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

To the accomplishment of the above and related objects the invention may be embodied in the form illustrated in the accompanying drawings. Attention is called to the fact, however, that the drawings are illustrative only. Variations are contemplated as being part of the invention, limited only by the scope of the claims.

### BRIEF DESCRIPTION OF THE DRAWINGS

In the drawings, like elements are depicted by like reference numerals. The drawings are briefly described as follows.

FIG. 1 is a perspective view of the inverted screw removal tool.

FIG. 2 is a side elevational view of the tool, illustrating employment of said tool in removing an inverted screw from a fuel pressure regulator.

FIG. 3 is a rear view of the tool, taken in the direction of arrow 3 in FIG. 2, showing the meshed gears in hidden lines.

### DETAILED DESCRIPTION OF THE PREFERRED EMBODIMENTS

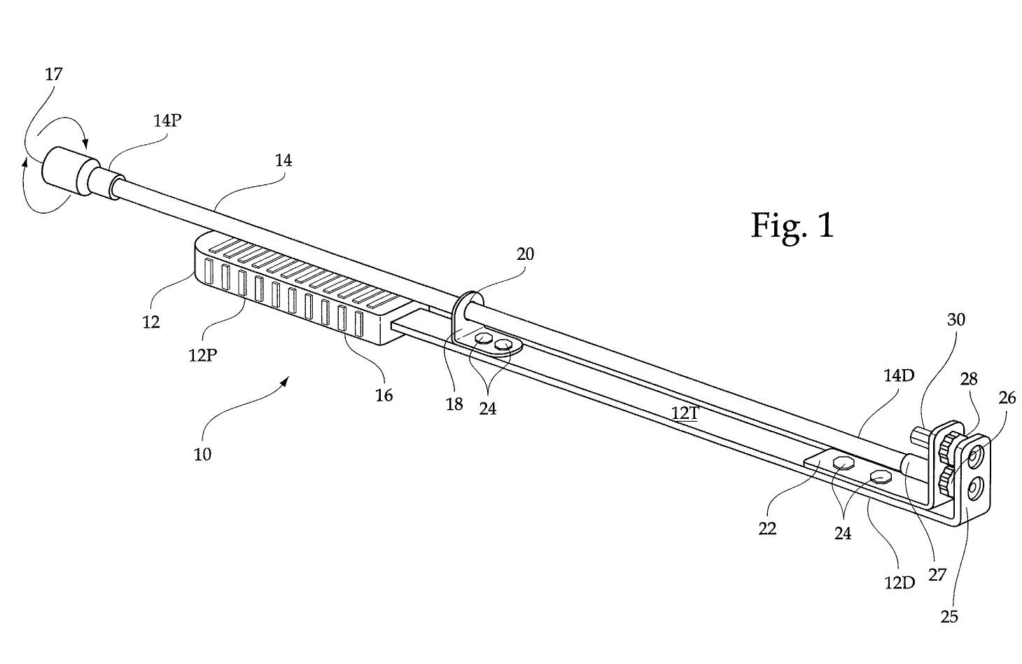

FIG. 1 illustrates a perspective view of an inverted screw removal tool 10. The tool 10 comprises a handle 12, having a proximal end 12P, a distal end 12D, and a top surface 12T. The tool 10 further comprises an elongated shaft 14, also having a proximal end 14P and a distal end 14D. The handle 12 is positioned below and parallel to the shaft 14, such that the shaft 14 is mounted to the handle 12 with a middle bracket 18 located between the proximal end 12P and distal end 12D of the handle.

The handle 12 has a rubber grip 16 covering the proximal end 12P. This grip 16 allows a user to hold the tool 10 tightly while manipulating said tool 10. The remainder of the handle 12 is substantially flat, but curves upward to form an end plate 25 which extends at a right angle at the distal end 12D.

The elongated shaft 14 is slightly longer than the handle 12, extending further proximally past the handle's proximal end 12P. The shaft 14 is a thin rotatable rod, with a socket 17 positioned at the proximal end 14P thereof. This socket 17 allows a user to turn the shaft 14, as illustrated in FIG. 1, using a driving mechanism, such as a ¼″ ratchet, a screw gun, etc.

The middle bracket 18 is attached to the handle 12 by rivets 24. The middle bracket 18 has a bore 20 through its vertical portion, said bore slightly larger in diameter than the shaft 14, thereby able to accommodate said shaft 14, supporting the shaft 14 while allowing axial rotation thereof.

An end bracket 22 is positioned just adjacent to the distal end 12D of the handle 12, and is also fastened to the top surface 12T of the handle 12 by rivets 24. This bracket 22 has two bores through its vertical portion, including a top bore and a bottom bore. A sleeve 27 extends horizontally from the bottom bore, pointed towards the proximal end 14P of the shaft 14. The distal end 14D of the shaft 14 is secured within the sleeve 27, and extends through the bottom bore for axial rotation therein. A bit 30 is mounted within the top bore for axial rotation therein, the bit 30 extending proximally from the end bracket 22. A shaft gear 26 and a bit gear 28 are positioned on the opposite side of the vertical portion of the bracket, between the end bracket 22 and the end plate 25. Accordingly, the end plate 26 extends parallel to the end bracket 22. The bit gear 28 is attached to the bit 30 so that it rotates with the bit 30, and the shaft gear 26 is attached to the shaft so that it rotates with the shaft 14. The gears 26 and 28 each have a plurality of teeth 36 situated along the perimeters, with equal sized spaces 38 between each tooth. The gears 26 and 28 mesh, so that when the shaft 14 is rotated, the bit 30 rotates in an opposite direction, as illustrated in FIG. 3.

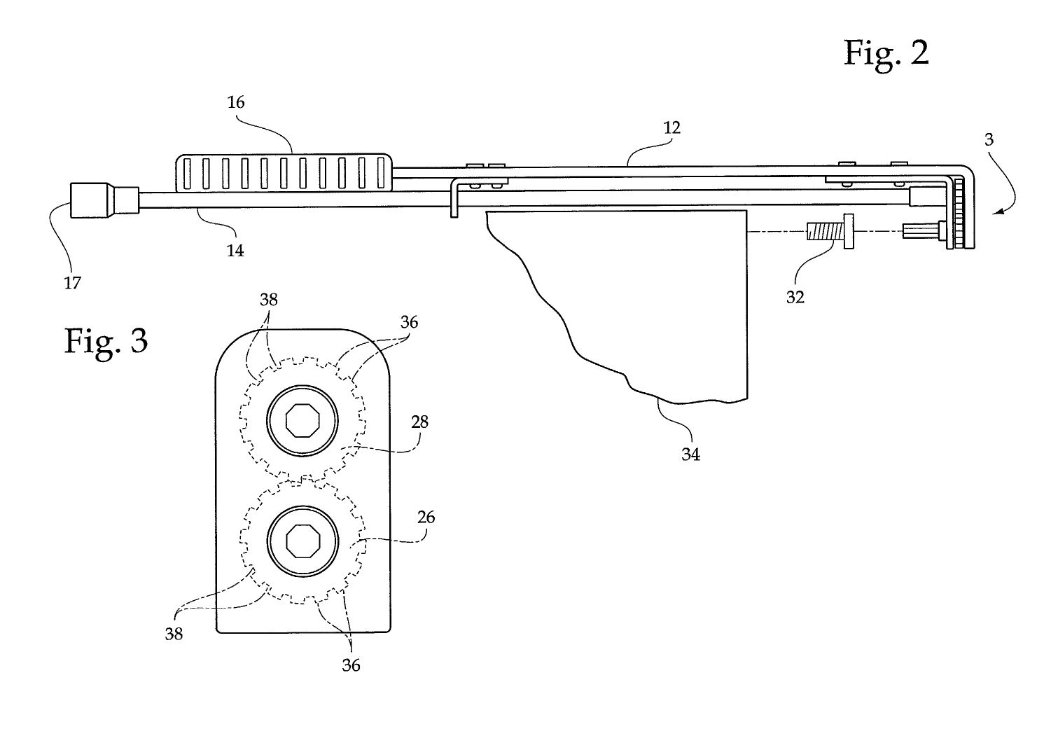

The tool 10 is illustrated in use in FIG. 2. In order to remove an inverted screw 32 in a fuel pressure regulator 34, an operator would hold the rubber grip 16 of the handle 12 with one hand, and place a driving mechanism in the socket 17 attached to the elongated shaft 14. The tool 10 is positioned and pulled toward the operator so that the bit 30 fits into and engages the inverted screw 32 of the regulator 34. Once in place, the operator would use the driving mechanism to rotate the shaft 14. By rotating the shaft 14, the bit 30 would also rotate in the opposite direction, by transmitting rotational force through the shaft gear 26 and bit gear 28. The bit 30 would then screw or unscrew the inverted screw 32, depending on the direction the shaft is rotated.

In conclusion, herein is presented a tool for removing inverted screws, particularly well suited for use with inverted allen screws present in an automobile fuel pressure regulator. The invention is illustrated by example in the drawing figures, and throughout the written description. It should be understood that numerous variations are possible, while adhering to the inventive concept. Such variations are contemplated as being a part of the present invention.

What is claimed is:

1. An inverted screw removal tool, comprising:
a shaft having a shaft proximal end and a shaft distal end;
a handle having a handle proximal end and a handle distal end, the handle having a middle bracket and an end bracket for supporting the shaft while allowing axial rotation of the shaft;
a bit, mounted to the end bracket so that said bit is capable of axial rotation, said bit extending parallel to the shaft and extending toward the proximal end of the shaft, said bit is mechanically engaged with the shaft so that rotation of the shaft causes rotation of the bit.

2. The inverted screw removal tool as recited in claim 1, further comprising a shaft gear, mounted to the shaft, a bit gear, mounted to the bit, and wherein the shaft gear engages the bit gear so that rotation of the shaft causes rotation of the bit.

3. The inverted screw removal tool as recited in claim 2, further comprising a socket located at the proximal end of the shaft, for allowing said shaft to be driven by a driver.

4. The inverted screw removal tool as recited in claim 3, wherein the handle has an end plate which extends from the distal end of the handle, and extends parallel to the end bracket, the bit gear and shaft gear are located between the end plate and end bracket.

5. The inverted screw removal tool as recited in claim 4, further comprising a rubber grip positioned at the proximal end of the handle, allowing an operator to securely hold the tool, and wherein the shaft extends further proximally than the rubber grip.

6. A method of removing an inverted screw, using an inverted screw removal tool, wherein the tool has a handle having a handle proximal end and a handle distal end, and an elongated shaft having a shaft proximal end and a shaft distal end, said shaft having a socket positioned at the shaft proximal end, said shaft attached to the handle with a middle bracket and an end bracket, said tool also having a bit positioned on the end bracket and extending parallel to the shaft, said bit extending toward the shaft proximal end, comprising the steps of:
holding the handle near the handle proximal end;
engaging the shaft proximal end with a driving mechanism;
positioning the tool so that the bit engages the inverted screw; and
rotating the screw by rotating the bit engaged with said screw, by rotating the shaft engaged with said bit.

6. The method as recited in claim 5, wherein the bit is mechanically linked with the shaft using a bit gear coaxially attached to the bit and a shaft gear coaxially attached to the shaft, the bit gear meshed with the shaft gear, and wherein the step of rotating the bit further comprises:
rotating the shaft gear by the shaft; and
rotating the bit gear by the shaft bear.
